(19) United States
(12) Patent Application Publication
(10) Pub. No.: US 2007/0086666 A1
(43) Pub. Date: Apr. 19, 2007

(54) Compatible interlaced sdtv and progressive hdtv

(75) Inventor: Wilhelmus Hendrikus Alfonsus Bruls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,601

(22) PCT Filed: Dec. 7, 2004
(86) PCT No.: PCT/IB04/52692

§ 371 Date: Jun. 19, 2006

(30) Foreign Application Priority Data
Dec. 22, 2003 (EP) 03104878.8

(51) Int. Cl. G06K 9/46

(52) U.S. Cl. 382/240

(57) ABSTRACT

A method and an apparatus for efficiently performing spatial scalable compression of video information captured in a plurality of frames including an encoder for encoding and outputting the captured video frames into a compressed data stream is disclosed. A base encoder for encoding an interlaced bitstream having a relatively lower pixel resolution. A spatial enhancement encoder for encoding a differential between a de-interlaced local decoder output from the base layer and an input signal.

### FIELD OF THE INVENTION

The invention relates to a video encoder/decoder, and more particularly to a compatible interlaced SDTV and progressive high resolution low bit rate coding scheme for use by a video encoder/decoder.

### BACKGROUND OF THE INVENTION

Because of the massive amounts of data inherent in digital video, the transmission of full-motion, high-definition digital video signals is a significant problem in the development of high-definition television. More particularly, each digital image frame is a still image formed from an array of pixels according to the display resolution of a particular system. As a result, the amounts of raw digital information included in high-resolution video sequences are massive. In order to reduce the amount of data that must be sent, compression schemes are used to compress the data. Various video compression standards or processes have been established, including, MPEG-2, MPEG-4, and H.263.

Many applications are enabled where video is available at various resolutions and/or qualities in one stream. Methods to accomplish this are loosely referred to as scalability techniques. There are three axes on which one can deploy scalability. The first is scalability on the time axis, often referred to as temporal scalability. Secondly, there is scalability on the quality axis (quantization), often referred to as signal-to-noise (SNR) scalability or fine-grain scalability. The third axis is the resolution axis (number of pixels in image) often referred to as spatial scalability. In layered coding, the bitstream is divided into two or more bitstreams, or layers. Each layer can be combined to form a single high quality signal. For example, the base layer may provide a lower quality video signal, while the enhancement layer provides additional information that can enhance the base layer image.

In particular, spatial scalability can provide compatibility between different video standards or decoder capabilities. With spatial scalability, the base layer video may have a lower resolution than the input video sequence, in which case the enhancement layer carries information which can restore the resolution of the base layer to the input sequence level.

FIG. 1 illustrates a known spatial scalable video encoder. The depicted encoding system accomplishes layer compression, whereby a portion of the channel is used for providing a low resolution base layer and the remaining portion is used for transmitting edge enhancement information, whereby the two signals may be recombined to bring the system up to high-resolution. The high resolution video input is split by splitter 102 whereby the data is sent to a low pass filter 104 and a subtraction circuit 106. The low pass filter 104 reduces the resolution of the video data, which is then fed to a base encoder 108. In general, low pass filters and encoders are well known in the art and are not described in detail herein for purposes of simplicity. The encoder 108 produces a lower resolution base stream which can be broadcast, received and via a decoder, displayed as is, although the base stream does not provide a resolution which would be considered as high-definition.

The output of the encoder 108 is also fed to a decoder 112 within the system 100. From there, the decoded signal is fed into an interpolate and upsample circuit 114. In general, the interpolate and upsample circuit 114 reconstructs the filtered out resolution from the decoded video stream and provides a video data stream having the same resolution as the high-resolution input. However, because of the filtering and the losses resulting from the encoding and decoding, loss of information is present in the reconstructed stream. The loss is determined in the subtraction circuit 106 by subtracting the reconstructed high-resolution stream from the original, unmodified high-resolution stream. The output of the subtraction circuit 106 is fed to an enhancement encoder 116 which outputs a reasonable quality enhancement stream.

Although these known layered compression schemes can be made to work quite well for progressive video, these schemes do not work well with video sent using interlaced SDTV standards. SDTV standards normally work well with interlaced video. For HDTV standards both interlace and progressive HDTV standards are used. Although the known layered compression schemes work for movies, e.g., SD/HD DVD's, the known schemes do not provide a sufficient solution for interlace SDTV and HDTV.

### SUMMARY OF THE INVENTION

The invention overcomes the deficiencies of other known layered compression schemes by introducing de-interlacers and re-interlacers into a layered compression scheme.

According to one embodiment of the invention, a method and an apparatus for efficiently performing spatial scalable compression of video information captured in a plurality of frames including an encoder for encoding and outputting the captured video frames into a compressed data stream is disclosed. A base encoder for encoding an interlaced bitstream having a relatively lower pixel resolution. A spatial enhancement encoder for encoding a differential between a de-interlaced local decoder output from the base layer and an input signal.

According to another embodiment of the invention, a method and apparatus for encoding an input video stream is disclosed. An interlaced video stream is created from the input video stream. The interlaced stream is encoded to produce a base stream. The base stream is de-interlaced, decoded and optionally upconverted to produce a reconstructed video stream. The reconstructed video stream is subtracted from the input video stream to produce a first residual stream. The resulting residual stream is encoded and outputted as an intermediate enhancement stream. The intermediate enhancement stream is temporal subsampled to produce a spatial enhancement stream.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 is a block diagram representing a known layered video encoder;

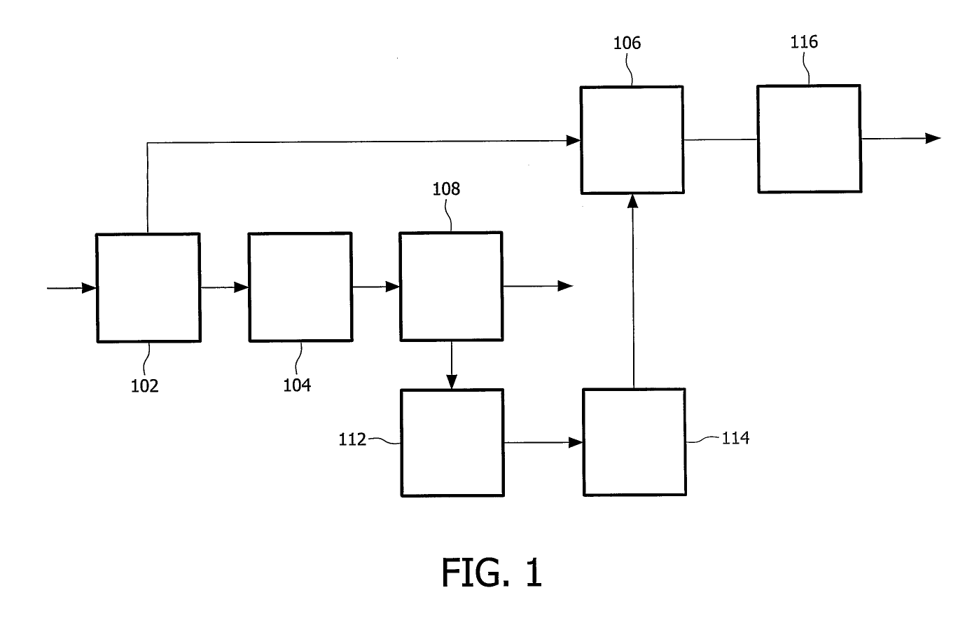

FIG. 2 is a block diagram of a layered video encoder according to one embodiment of the invention;

FIG. 3 is a block diagram of a layered video decoder according to one embodiment of the invention;

FIG. 4 is a block diagram of a layered video encoder according to one embodiment of the invention.

### DETAILED DESCRIPTION OF THE INVENTION

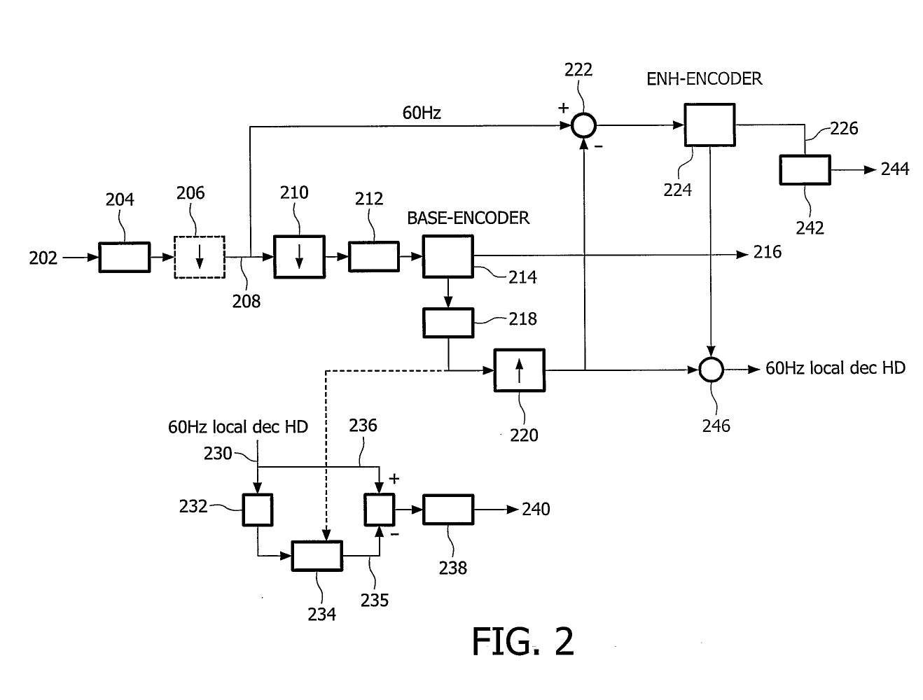

FIG. 2 is a block diagram of a layered video encoder according to one embodiment of the invention. A high-resolution video stream 202 is inputted into a de-interlacer 204. The de-interlacer 204 de-interlaces the input stream 202 and outputs a non-interlaced progressive signal composed of single frames. The non-interlaced signal is then downsampled by an optional downsampling unit 206. The decoupled video stream is then split by a splitter 208, whereby the video stream is sent to a second low pass filter/downsampling unit 210 and a subtraction unit 222. The low pass filter or downsampling unit 210 reduces the resolution of the video stream, which is then fed to an interlacer 212. The interlacer 212 re-interlaces the video signal and then feeds the output to a base encoder 214. The base encoder 214 encodes the downsampled video stream in a known manner and outputs a base stream 216. In this embodiment, the base encoder 214 outputs a local decoder output to a de-interlacer 218, which de-interlaces the output signal and provides a de-interlaced output signal to an upconverting unit 220. The upconverting unit 220 reconstructs the filtered out resolution from the local decoded video stream and provides a reconstructed video stream having basically the same resolution format as the high-resolution input video stream in a known manner. Alternatively, the base encoder 214 may output an encoded output to the upconverting unit 220, wherein either a separate decoder (not illustrated) or a decoder provided in the upconverting unit 220 will have to first decode the encoded signal before it is upconverted.

The reconstructed video stream from the upconverting unit 220 and the high-resolution input video stream are inputted into the subtraction unit 222. The subtraction unit 222 subtracts the reconstructed video stream from the input video stream to produce a residual stream. The residual stream is then encoded by an enhancement encoder 224 to produce an intermediate enhancement stream 226. The intermediate enhancement stream is supplied to the temporal subsampling unit 242 which subsamples the intermediate enhancement stream to produce a spatial enhancement stream 244.

The encoder 214 also supplies the local decoder output to an addition unit 246, which combines the local base decoder output to a local enhancement decoder output from the enhancement encoder 224. The combined local decoder output is supplied to a splitter 230, which supplies the combined local decoder output to a temporal subsampling unit 232 and an evaluation unit 236. The temporal subsampling unit 232 performs the same temporal subsampling as the encoder 214 performs on the original video input. The result is a 30 Hz signal. This reduced signal is fed to a motion compensated temporal interpolation unit 234, that is embodied in this example as a natural motion estimator. The motion compensated temporal interpolation unit 234 performs an upconversion from 30 Hz to 60 Hz by estimating additional frames. The motion compensated temporal interpolation unit 234 performs the same upconversion as later the decoder will perform when decoding the coded data stream. Any motion estimation method can be employed according to the invention. In particular, goods results can be obtained with motion estimation based on natural or true motion estimation as used in for example frame rate conversion methods. A very cost efficient implementation is for example three-dimensional recursive search (3DRS) which is suitable for consumer applications, see for example U.S. Pat. Nos. 5,072,293, 5,148,269, and 5,212,548. The motion-vectors estimated using 3DRS tend to be equal to the true motion, and the motion-vector field inhibits a high degree of spatial and temporal consistency. Thus, the vector inconsistency is not thresholded very often and consequently, the amount of residual data transmitted is reduced compared to non-true motion estimations.

The upconverted signal 235 is sent to an evaluation unit 236. As mentioned above, the evaluation unit is also supplied with the combined local decoder output from the splitter 230. The evaluation unit 236 compares the interpolated frames as determined by the motion compensated temporal interpolation unit 234 with the actual frames. From the comparison, it is determined where the estimated frames differ from the actual frames. Differences in the respective frames are evaluated, in case the differences meet certain threshold values, the differential data is selected as residual data. The thresholds can, for example, be related to how noticeable the differences are, such threshold criteria per se are known in the art. In this example, the residual data is described in the form of meta blocks. The residual data stream 237 in the form of meta blocks is then put into an encoder 238. The encoder 238 encodes the residual stream 237 and produces a temporal enhancement stream 240.

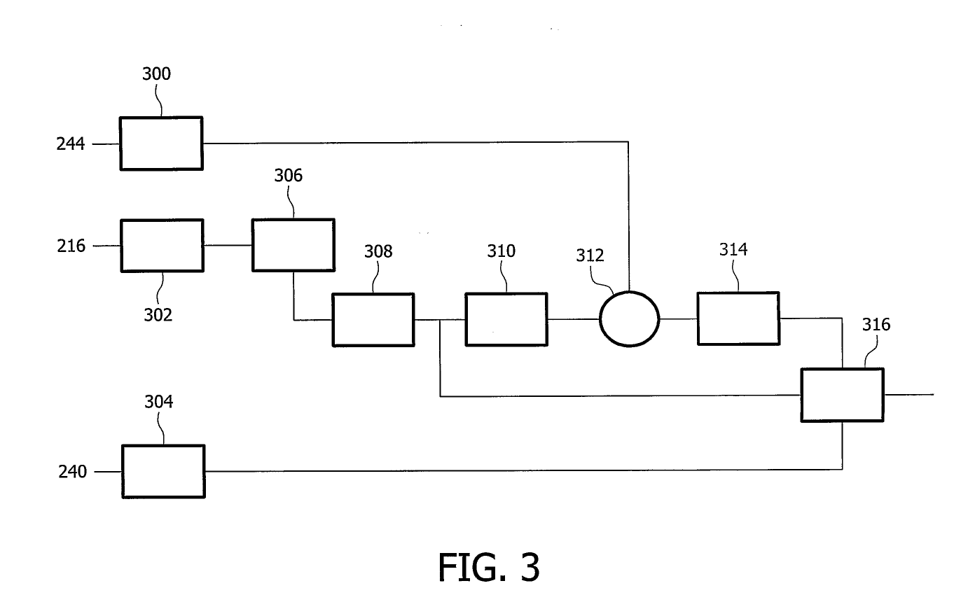

FIG. 3 illustrates an exemplary decoder section according to one embodiment of the invention. In the decoder section, the base stream 216 is decoded in a known manner by a decoder 302, and the spatial enhancement stream 244 is decoded in a known manner by a decoder 300. The decoded base stream is then de-interlaced by a de-interlacing unit 306. The de-interlaced stream is then optionally upsampled in the upsampling unit 308. The upsampled stream is then temporal subsampled by the temporal subsampling unit 310. The subsampled stream is then combined with the decoded spatial enhancement stream in the addition unit 312. The combined signal is then interpolated by a motion compensating temporal interpolation unit 314. The temporal enhancement stream 240 is decoded in a known manner by a decoder 304. A combination unit 316 combines the decoded temporal enhancement stream, the interpolated stream and the upsampled stream to produce a decoder output.

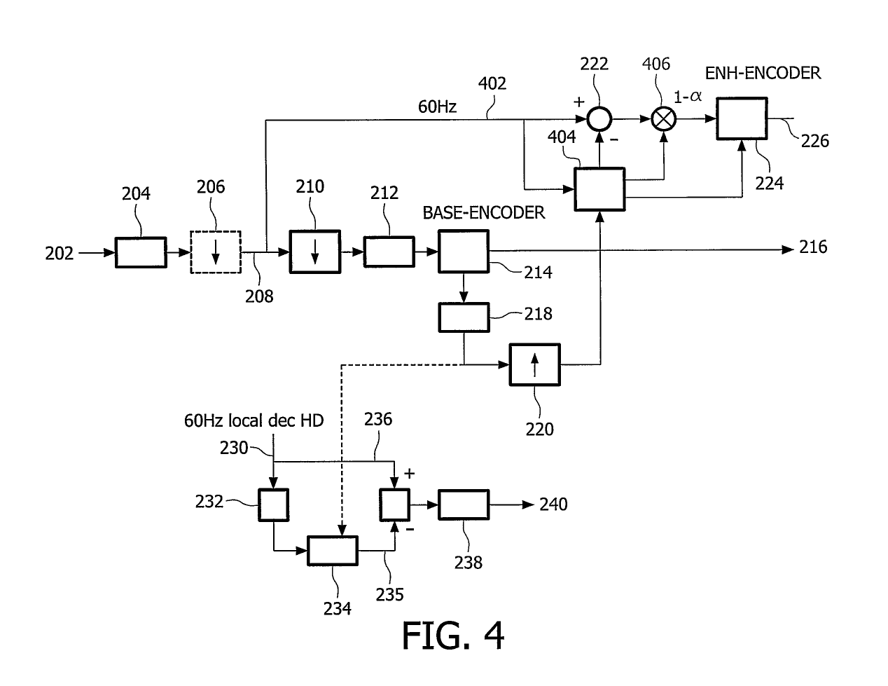

FIG. 4 illustrates an encoder according to another embodiment of the invention. In this embodiment, a picture analyzer 404 has been added to the encoder illustrated in FIG. 2 to provide dynamic resolution control. A splitter 402 splits the high-resolution input video stream 202, whereby the input video stream 202 is sent to the subtraction unit 222 and the picture analyzer 404. In addition, the reconstructed video stream from the upconverting unit 220 is also inputted into the picture analyzer 404 and the subtraction unit 222. The picture analyzer 404 analyzes the frames of the input stream and/or the frames of the reconstructed video stream and produces a numerical gain value of the content of each pixel or group of pixels in each frame of the video stream. The numerical gain value is comprised of the location of the pixel or group of pixels given by, for example, the x,y coordinates of the pixel or group of pixels in a frame, the frame number, and a gain value. When the pixel or group of pixels has a lot of detail, the gain value moves toward a maximum value of “1”. Likewise, when the pixel or group of pixels does not have much detail, the gain value moves toward a minimum value of “0”. Several examples of detail criteria for the picture analyzer are described below, but the invention is not limited to these examples. First, the picture analyzer can analyze the local spread around the pixel versus the average pixel spread over the whole frame. The picture analyzer could also analyze the edge level, e.g., abs of
−1−1−1
−1 8−1
−1−1−1
   per pixel divided over average value over whole frame.

The gain values for varying degrees of detail can be predetermined and stored in a look-up table for recall once the level of detail for each pixel or group of pixels is determined.

As mentioned above, the reconstructed video stream and the high-resolution input video stream are inputted into the subtraction unit 222. The subtraction unit 222 subtracts the reconstructed video stream from the input video stream to produce a residual stream. The gain values from the picture analyzer 404 are sent to a multiplier 406 which is used to control the attenuation of the residual stream. In an alternative embodiment, the picture analyzer 404 can be removed from the system and predetermined gain values can be loaded into the multiplier 406. The effect of multiplying the residual stream by the gain values is that a kind of filtering takes place for areas of each frame that have little detail. In such areas, normally a lot of bits would have to be spent on mostly irrelevant little details or noise. But by multiplying the residual stream by gain values which move toward zero for areas of little or no detail, these bits can be removed from the residual stream before being encoded in the enhancement encoder 224. Likewise, the multipler will move toward one for edges and/or text areas and only those areas will be encoded . The effect on normal pictures can be a large saving on bits. Although the quality of the video will be affected somewhat, in relation to the savings of the bitrate, this is a good compromise especially when compared to normal compression techniques at the same overall bitrate.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

1. An apparatus for efficiently performing spatial scalable compression of video information captured in a plurality of frames including an encoder for encoding and outputting the captured video frames into a compressed data stream, comprising:
a base encoder (214) for encoding an interlaced bitstream having a relatively lower pixel resolution;
a spatial enhancement encoder (224) for encoding a differential between a de-interlaced local decoder output from the base layer and an input signal for producing an intermediate enhancement stream.

2. The apparatus according to claim 1, wherein a de-interlaced local decoder output is upsampled prior to the spatial enhancement encoder.

3. The apparatus according to claim 1, wherein the input signal is a de-interlaced version of the original interlaced input signal.

4. The apparatus according to claim 1, wherein the input signal is a downsampled version of the original input signal.

5. The apparatus according to claim 4, wherein a downsampler (210) is used for creating a base stream which is inputted into the base encoder.

6. The apparatus according to claim 5, wherein a re-interlacer (212) is used to create an interlaced base stream which is encoded by the base encoder.

7. The apparatus according to claim 1, further comprising:
temporal subsampling unit (232) for subsampling the intermediate enhancement stream to produce a spatial enhancement stream.

8. The apparatus according to claim 7, further comprising:
means (246) for adding together the local decoder outputs of the base encoder and the enhancement encoder;
means (232) for temporally subsampling the combined local decoder;
means (234) for applying motion compensated temporal interpolation to the temporally subsampled signal.

9. The apparatus according to claim 8, wherein the output of the local decoder of the base encoder is compared with the temporal interpolated signal.

10. The apparatus according to claim 9, wherein information is encoded as a temporal enhancement signal on groups of pixels when said comparison exceeds a predetermined threshold value.

11. The apparatus according to claim 8, wherein the motion compensated temporal interpolation is natural motion interpolation.

12. The apparatus according to claim 11, wherein the motion estimation of the temporal interpolation makes use of the local decoder signal of the base encoder.

13. The apparatus according to claim 1, further comprising:
a multiplication unit (242) for multiplying input signal to the spatial enhancement encoder.

14. The apparatus according to claim 13, further comprising:
a signal analyzer (404) for controlling a gain of the multiplication unit.

15. A layered encoder for encoding an input video stream, comprising: an interlacer unit (212) for creating an interlaced base signal from the input video stream
a base encoder (214) for encoding the interlaced base stream which has a lower pixel rate;
a de-interlacer (218) for de-interlacing a local decoder output from the base encoder;
a subtractor unit (222) for subtracting the de-interlaced stream from the input video stream to produce a residual signal;
an enhancement encoder (226) for encoding the residual signal and outputting an intermediate enhancement stream.

16. The layered encoder according to claim 15, further comprising: a temporal subsampling unit (232) for sampling the intermediate enhancement stream and outputting a spatial enhancement stream.

17. The layered encoder according to claim 16, further comprising:
an temporal subsampler (232) for temporal subsampling a combined local decoder output of the base encoder and the enhancement encoder;
a motion compensated temporal interpolation unit (234) for performing motion estimation on a signal outputted by the temporal subsampler;
an evaluation unit (236) for comparing interpolated frames from the motion compensated temporal interpolation unit with actual frames from the local base decoder, and selecting data as a temporal residual stream when the comparison exceeds a predetermined threshold value; and
a temporal encoder (238) for encoding the temporal residual stream to produce a temporal enhancement stream.

18. The layered encoder according to claim 17, wherein the temporal encoder is being realized by muting information of the enhancement encoder.

19. A method for encoding an input video stream, comprising the steps of:
creating an interlaced video stream from the input video stream encoding the interlaced video stream to produce a base stream;
de-interlacing a local decoder output from a base encoder;
subtracting the de-interlaced stream from the input video stream to produce a first residual stream;
encoding the resulting residual stream and outputting an spatial enhancement stream.

20. The method according to claim 19, further comprising the step of:
temporal subsampling the intermediate enhancement stream to produce a spatial enhancement stream.

21. The method according to claim 20, further comprising the steps of: performing a temporal subsampling a combined local decoder output of the base encoder and the enhancement encoder;
performing motion estimation on a signal outputted by an temporal subsampler;
comparing interpolated frames from a motion compensated temporal interpolation unit with actual frames from the local base decoder, and selecting data as a temporal residual stream when the comparison exceeds a predetermined threshold value; and
encoding the temporal residual stream to produce a temporal enhancement stream.

22. A decoder, comprising:
a first decoder (300) for decoding a spatial enhancement stream;
a second decoder (302) for decoding a base stream;
a de-interlacer (306) for de-interlacing the decoded base stream;
an addition unit (312) for adding the de-interlaced decoded base stream and the decoded spatial enhancement stream.

23. The decoder according to claim 22, further comprising;
an upsampling unit (308) for upsampling the de-interlaced stream prior to the addition unit.

24. The decoder according to claim 22, further comprising:
a temporal subsampling unit (310) for temporal subsampling the de-interlaced base stream;
a motion compensation temporal interpolation unit (314) for interpolating an output from the addition unit;
a third decoder (304) for decoding a temporal enhancement stream;
a combination unit (316) for combining the upsampled stream, the interpolated stream and the decoded temporal enhancement stream to produce a decoder output.
